(19) United States
(12) Patent Application Publication
(10) Pub. No.: US 2004/0064839 A1
(43) Pub. Date: Apr. 1, 2004

(54) System and method for using speech recognition control unit

(76) Inventor: Daniel R. Watkins, Saratoga, CA (US)

Correspondence Address: LSI LOGIC CORPORATION, 1621 BARBER LANE, MS: D-106 LEGAL, MILPITAS, CA, 95035, US

(21) Appl. No.: 10/260,240

(22) Filed: Sep. 30, 2002

(51) Int. Cl. H04N 7/173

(52) U.S. Cl. 725/131; 725/134

(57) ABSTRACT

A speech recognition remote control unit (SR RCU) having the ability to leverage the advanced processing and memory capabilities of a settop box in order to provide enhanced SR capability and enhanced user control of components in an audio-video system. Programming of commands takes place in either the SR RCU or in the settop box, or both. Commands programmed into the settop box may be initiated by speech communications received by the SR RCU that are then sent to the settop box via wireless transfer. The initiated commands may further be sent to a device either directly from the settop box, or via relay from the settop box to the SR RCU, and then to the device. The SR RCU may be capable of receiving both speech communications and wireless information.

### FIELD OF THE INVENTION

This invention relates generally to a system for controlling audio, video and other apparatus using a speech recognition remote control unit (SR RCU), and, more particularly, to using a SR RCU and a settop box to provide enhanced speech recognition control over components typically found in an audio-video system.

### BACKGROUND OF THE INVENTION

In many audio-video systems today, a “settop box” is used to receive communicated services and to interface with the user. Originally, the primary role for settop boxes was to allow conditional access to the communicated services. Conditional access (CA) refers generally to a technology used to control access to communicated services such as television programming. Several different CA schemes currently exist. The transmissions conveying such communicated services are typically scrambled or encrypted, and only authorized users are provided with means to descramble or decrypt the transmissions. Scrambling typically involves modifying a transmission signal by, for example, removing synchronization pulses. Encryption typically involves modifying digital data conveyed by the transmission signal according to a particular cryptographic algorithm. Conditional access has been used for many years to provide exclusive access to premium television channels and special broadcasts (e.g., sporting events and pay-per-view movies). Conditional access can also be used to provide exclusive access to digital radio broadcasts, digital data broadcasts, and interactive services. Known CA technologies for scrambling or encrypting television transmissions include VideoCrypt™ (Thomson Consumer Electronics, S A FR), VideoCipher® and DigiCipher® (NextLevel Systems, Inc., Chicago, Ill.).

A typical CA system used to scramble or encrypt television programming generally includes CA encoding equipment integrated into broadcast equipment (e.g., cable, satellite, or terrestrial broadcast equipment) at a service provider's location. In general, the CA encoding equipment modifies (i.e., scrambles or encrypts) information conveyed by a transmission signal produced by the broadcast equipment. Where the CA encoding equipment employs encryption, the CA encoding equipment encrypts digital data (e.g., digitized video and audio information), and the broadcast equipment transmits a signal conveying the encrypted digital data to the subscribers. The CA encoding equipment may also insert messages into the transmission signal that provide information necessary for decryption of the encrypted digital data.

The typical CA system also includes CA decoding equipment at each subscriber's location. The CA decoding equipment typically includes a box receiving the transmission signal capable of being coupled to a television set or other display means. Such boxes are commonly referred to as “settop boxes” or integrated receiver decoders (IRDs). A typical settop box decrypts the encrypted digital data in the transmission signal, converts the digital data to analog signals (e.g., analog video and audio signals), and provides the analog signals for display on a television set or other display means. Accordingly, settop boxes have relatively sophisticated processing capability.

In addition to this relatively sophisticated capability, current settop boxes are being asked to provide more and more functionality to the audio-video systems in which they are coupled. For example, the settop box may provide menus via the display or television to allow the user to control and interact with the system via a user-friendly, graphical user interface (GUI). In addition, the settop box may provide personal video recording (PVR) capabilities in which the communicated services may be recorded, edited, modified, etc. To provide these increasingly sophisticated and enhanced control and interfacing services via the settop box, the settop boxes have generally had to incorporate increasingly sophisticated additional processing capability, including hardware and software. Given the relative complexity of the functions and capabilities now offered via settop boxes, then, the typical settop box now has relatively sophisticated internal hardware and software capabilities.

Most audio-video systems usually also incorporate at least one remote control units (RCUs). RCUs are commonly used for controlling various devices such as television sets, VCRs, DVD players, stereos, vehicles, computers, etc. A common example of the employment of a simple RCU 10 is illustrated by FIG. 1, where the RCU 10 is used to control a television 30 via commands transmitted to a settop box 20 that is coupled to the television. Commercially available examples of this embodiment include common satellite or cable television systems where the content is fed through the settop box 20 to the television 30, and the television's 30 functions are manipulated via the settop box 20, which receives wireless commands from the RCU 10.

In a slightly more advanced form, a single RCU may be capable of manipulating multiple devices manufactured by different vendors. Such a single universal RCU may be programmed to control an entire home entertainment system including multiple devices such as a television, stereo, DVD player, and VCR. FIG. 2 shows the RCU 50 capable of controlling a television 30 and VCR 40 via wireless communications. Most often such a universal RCU 50 directly controls each device separately. However, in some applications, the RCU 50 interfaces with a settop box 20 in order to control one or more of the devices. That is, a control command may be initiated at the RCU 50, sent to a settop box 20, and then sent by the settop box to another component in the system via wireless or wireline communications.

In order to further enhance the ability of a user to control components via an RCU, voice recognition, or speech recognition (SR), has also been added to RCUs for controlling devices such as entertainment systems including televisions, VCRs, stereos, and the like. In these applications, however, the ability to add SR capabilities to an RCU is limited by the processing power in the RCU. In particular, high-level SR capabilities can require very complex and sophisticated processes incorporating DSP algorithms, a digital to analog conversion, etc. Advanced SR functions and capability require fairly sophisticated processing capacity not typically found in RCUs. To add the necessary level of processing power to an RCU poses several problems, including cost, size, etc. Accordingly, current attempts to incorporate SR capability into an RCU have only provided relatively simple SR functions. For example, the speech recognition capability is generally limited to the recognition of simple speech commands such that each single voice command corresponds to a single button on the RCU. Generally it has not been feasible to greatly enhance the functionality of a speech recognition remote control unit (SR RCU) by adding additional memory and processing capabilities, and thereby also greatly increasing the complexity and cost of the SR RCU, since such expensive RCUs would probably not be very viable in the marketplace.

### SUMMARY OF THE INVENTION

In accordance with the present invention, a speech recognition remote control unit (SR RCU) is provided that leverages the advanced processing capabilities of the settop box to provide enhanced speech recognition capability to an RCU. By possessing the capability to receive both wireless and speech communications, as well as send wireless communications to a settop box and/or other equipment, the SR RCU may take advantage of the greater processing and storage capabilities in a settop box to perform enhanced SR and related functions within the settop box.

In one embodiment, the SR RCU receives commands in the form of speech communications and sends them to the settop box via wireless transfer. Processing of the information contained in the speech communication may take place in the settop box, which then sends the resultant wireless command back to the SR RCU where it may be relayed to a third remote component in the system.

### BRIEF DESCRIPTION OF THE DRAWINGS

FIG. 1 is a block diagram illustrating one prior art application of a simple remote control unit.

FIG. 2 is a block diagram illustrating a prior art application of a universal remote control unit.

FIG. 3 is a block diagram of an embodiment of a system for enhanced user control of an audio-video system comprising a speech recognition remote control unit (SR RCU) in combination with a settop box in accordance with the present invention.

FIG. 4 is a block diagram of an embodiment of a speech recognition remote control unit used in combination with a settop box in accordance with the present invention.

### DETAILED DESCRIPTION OF EMBODIMENTS

In this disclosure, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, some details, such as details concerning network communications, electromagnetic signaling techniques, and the like, have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise. Certain terms are used throughout the following description and claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or communicative connection. Thus, if a first device couples to a second device, that connection may be through a direct connection, or through an indirect connection via other devices and connections.

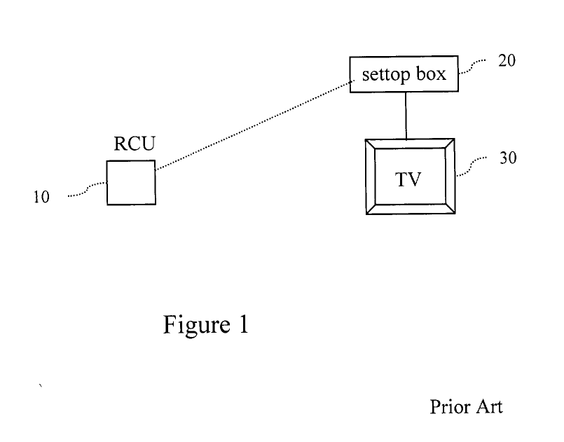

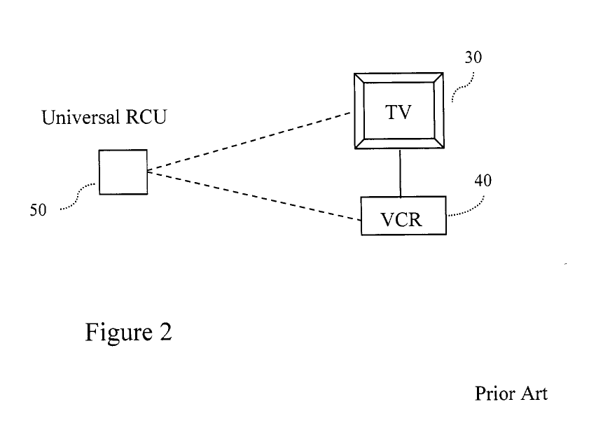

FIG. 1 and FIG. 2 have been described above.

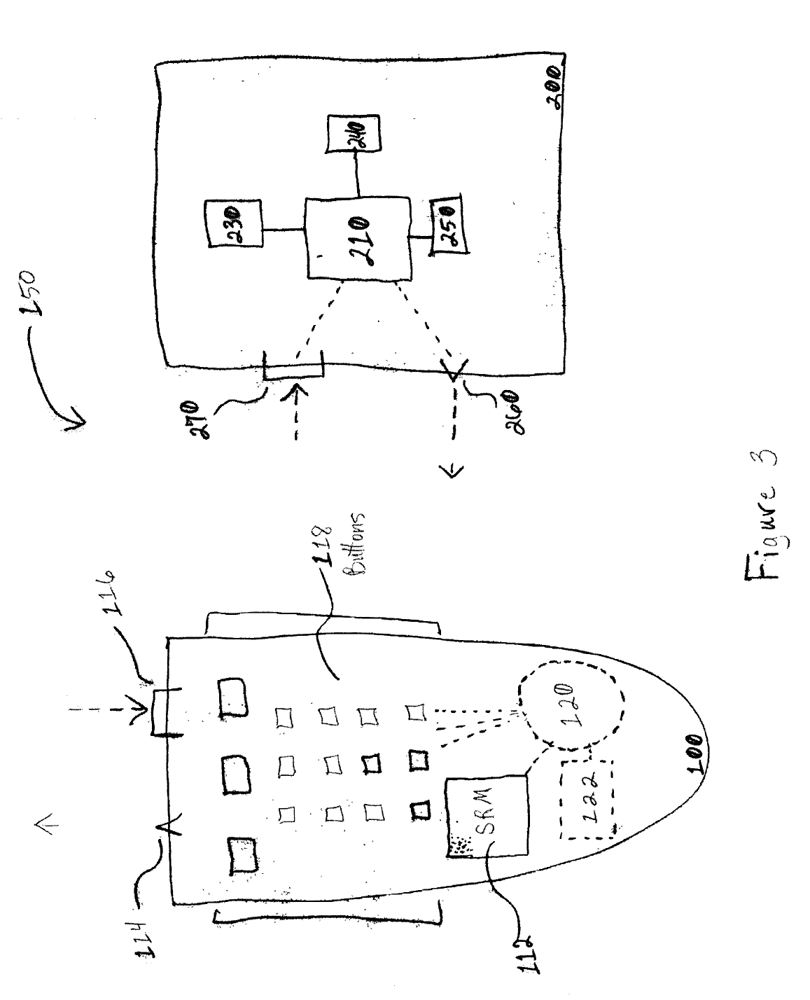

FIG. 3 illustrates an embodiment of a system 150 for enhanced user control of an audio-video system comprising a SR RCU 100 and a settop box 200. The SR RCU comprises buttons 118 for entering commands, a RCU transmitter 114 for sending wireless information, a RCU receiver 116 for capturing wireless information, a RCU speech recognition module 112 for capturing and possibly processing speech communications, and at least one RCU processor 120 for processing information related to controlling an audio-video system. In addition, depending on the sophistication of the SR RCU 100, the SR RCU 100 may contain a memory module 122 that provides storage for data and software. The buttons 118, RCU transmitter 114, RCU receiver 116, memory module 122, and RCU speech recognition module 112 are typically coupled to at least one RCU processor 120 for sending, receiving, storing and processing information.

The buttons 118 of the SR RCU 100 are typical of simple RCUs. A user pushes the buttons 118 to issue a command to a component of an audio-video system, such as a television, to perform simple functions such as “on” or “channel up”. The buttons are coupled to at least one RCU processor 120, which is also coupled to a RCU transmitter 114. Pressing a button 118 sends a signal to the RCU processor 120, which processes the signal for transmission via the RCU transmitter 114. The RCU transmitter 114 sends the command signal to a component of an audio-visual system, either directly or indirectly via a settop box 200. Buttons 118 may also be used to perform more complex tasks such as interfacing with menus on a display, typically via a settop box.

The RCU transmitter 114 is coupled to at least one RCU processor 120 and is the means by which the SR RCU 100 sends wireless information to either the settop box 200 or directly to another component of an audio-visual system. The RCU transmitter 114 relays signals from the RCU processor 120 that may originate from either the RCU speech recognition module 112, the RCU receiver 116, or the buttons 118. The RCU transmitter 114 may be any type of wireless communication device for audio-video control applications, such as an infrared (IR) transmitter, radio frequency (RF) transmitter, etc.

Like the RCU transmitter 114, the RCU receiver 116 for audio-video control applications may be any type of wireless receiver, such as an IR receiver, RF receiver, etc. The RCU receiver 116 is coupled to at least one RCU processor 120 and is the means by which the SR RCU 100 captures signals from the settop box 200. Signals collected by the RCU receiver 116 are handled by the RCU processor 120. Often these signals are processed and then a corresponding signal is relayed via the RCU transmitter 114 to one of the components of the audio-video system. Depending on the capabilities of the SR RCU 100, the RCU receiver 116 and RCU processor 120 may also collect information from the settop box 200 related to programming of the SR RCU 100 itself, in which case the information captured by the RCU receiver 116 would not be relayed.

The speech recognition module (SRM) 112 is coupled to at least one RCU processor 120 and the RCU transmitter 114. Speech communications from a user are captured by the SRM 112 and converted to data using some level of speech recognition analog to digital conversion algorithms. The SRM 112 generally comprises an element for capturing speech communications, such as a microphone, as well as software incorporating the algorithms for converting the captured speech communications to data. Data resulting from the conversion of speech communications can then be transmitted from the SR RCU 100 to either a settop box 200 or other device. The sophistication of the speech communication capture element, its software, and the RCU processor 120 affect the complexity and quality of speech recognition possible within the SRM 112 of the SR RCU 100. The quality of speech recognition can be greatly enhanced, however, by performing relatively simple analog-digital conversion of the captured speech communications in the SR RCU 100 then passing the data to a settop box 200 for more sophisticated speech recognition processing.

The SR RCU 100 contains at least one RCU processor 120 that is coupled to the SRM 112, the RCU transmitter 114, the buttons 118, any memory module 122, and the RCU receiver 116. An RCU processor 120 handles many tasks within the SR RCU 100, including conversion of speech communications and button 118 commands to transmittable data, relaying data from the RCU receiver 116, relaying data to the RCU transmitter 114, and accessing and storing data in a memory module 122. Depending on the sophistication of the RCU processor 120, it may process more or less complex speech communications and it may perform more or less advanced SR algorithms for quality and accuracy. The capacity of any memory module 122 in the SR RCU 100 may also have to be increased if the RCU processor's 120 capability is enhanced enough to perform more advanced speech communication processing functions within the SR RCU 100 without accessing the speech communication processing capabilities of the settop box 200. It is desirable, however, to leverage the sophisticated processing capabilities of the settop box 200, however, in order to keep the complexity and resulting cost of the SR RCU 100 down.

The settop box (SB) 200 comprises at least one SB processor 210 coupled to a SB SRM 230, SB transmitter 260, SB receiver 270, memory or recording module 240, and menu module 250. The settop box 200 and its component parts typically process information related to receiving communicated services such as television broadcasts, display those services to an audio-video system, and controlling components within the audio-video system.

The SB processor 210 typically possesses relatively sophisticated processing power in order to handle all of the functions of the settop box 200. For example, for a given speech communication received by the settop box 200, the SB processor 210 may relay the data in the communication to the SB SRM 230, interface with the SB SRM 230 and the memory module 240 to interpret the information contained in the speech communication, and associate the information with a specific function. Ultimately, based on the information received in a user's speech communication, the SB processor 210 relays the information necessary to execute the user's command to the audio-video system via the SB transmitter 260. The SB processor 210 also interfaces with the recording module 240 when, for example, adding or modifying programmed tasks, or when recording or playing one or more audio or video programs. In addition, the SB processor 210 is coupled to the menu module 250, which provides the ability to exhibit menus on a display as a user manipulates the system. Examples of commercially available SB processors 210 include the LSI Logic SC2X and LSI Logic 9600.

The SB SRM 230 is coupled to the SB processor 210 and the memory module 240. The SB SRM 230 may or may not include a speech communication capture element, such as a microphone, for directly collecting speech communications from a user. If the settop box 200 is designed to directly interface via speech communications with a user, then one function of the SB SRM 230 would be to convert the speech communication to data. If, on the other hand, the speech communications are captured by the SR RCU 100 then the conversion would be performed in the SR RCU 100 and the function of the SB SRM 230 would be to receive the data from the SR RCU 100 then interface with the SB processor 210 and memory module 240 in order to interpret the information contained in the data communication from the SR RCU 100 and initiate the appropriate function or action based on the user's command.

The SB transmitter 260 couples with the SB processor 210 to send commands and control functions in the form of wireless information to the audio-video system, either directly or via the SR RCU 100. Common SB transmitters 260 compatible with audio-video control applications include IR transmitters, RF transmitters, and the like. Similarly, the SB receiver 270 couples with the SB processor 210 to receive wireless information from the SR RCU 100 or other devices. The data is relayed from the SB receiver 270 by the SB Processor 210 and, in the case of data from a speech communication, is interpreted and associated with the appropriate function by the SB processor 210 interfacing with the SB SRM 230 and the memory module 250. Common SB receivers 270 compatible with audio-video control applications include IR and RF receivers.

The memory or recording module 240 is coupled to at least the SB processor 210. Uses of the memory module 240 include storage of software that integrates the system 150, recording of audio and video programs, and recording of executable commands by a user. Typically, the memory capacity in a SB 200 is significantly greater than that available in a SR RCU 100. The recording module 240 couples with the SB processor 210 and the SB SRM 230 to interpret speech communication commands received from a user. In addition, execution of user commands requires the SB processor 210 to access the memory module 240 in order to, among other things, record and play audio and video programs.

The menu module 250 couples with the SB processor to provide enhanced display menus, such as on a television screen, in order to assist the user in manipulating and controlling the audio-video system. The menu module 250 may provide visual feedback to the user that a particular command is being executed. In addition, the menus associated with the menu module 250 may provide a user the ability to control and interact with the system via a user-friendly, graphical user interface (GUI).

The SR RCU 100 of the present invention may possess more or less functionality depending on the application. At one extreme, the SR RCU 100 may be nothing more than a conduit for communications between a user, settop box 200, and one or more devices. In such a case the SR RCU 100 capabilities, such as memory and processing capability, are minimized, which also minimizes size and cost, and virtually all storage and processing functions are performed by the settop box 200. On the other hand, any degree of processing, programming, and storage capability may be included in the SR RCU so that it is capable of operating without a settop box altogether, or, perhaps preferably, so that the SR RCU may manage simple commands such as “on,” “off”, “channel up”, or “volume down” that are communicated directly to a device, such as a television, while the processing and functions associated with execution of more complicated commands/programs are performed by the settop box 200. The present invention permits a simple SR RCU to leverage the greater processing and storage capability within a settop box 200, so that the speech communication recognition function is greatly enhanced, and so that more complex commands and programs are executable via a SR RCU.

In theory, if a settop box 200 possesses its own element for capturing speech communications 280, it alone is capable of supporting all the functions of the SR RCU 100—settop box 200 combination. However, using the settop box 200 without an SR RCU 100 is less convenient and practical for users, and may mean less flexibility with regard to layout of the system to be controlled since the speech commands would have to be issued in proximity to the settop box 200 or loud enough that the settop box 200 can receive them. Thus, it is believed the practicality and functionality of incorporating speech recognition capabilities in an audio-video system are maximized when the SR RCU 100 is used in conjunction with a settop box 200.

With the present invention, the processes within the settop box 200 can be compared to those within the SR RCU 100. The key differences are the typically greater processing and storage capabilities of the settop box 200 created by the more sophisticated SB processor 210 and the significantly greater capacity in the recording module 240. Software in the settop box 200 allows the SB processor 210 to process speech communications from a user (whether relayed by an SR RCU 100, or received directly through the settop box's own speech communication capture element, or microphone) via the SB SRM 230, and based on the content of the speech communication, execute a myriad of programming, recording, and command functions related to one or more devices and the content (e.g., television and/or radio programming, music from a CD, or video from a VCR or DVD) available to the user from those devices. The greater processing and storage capability makes recognition of even simple speech commands more accurate, and allows for recognition of much more complex verbal commands with a higher level of quality.

A user may interface with the settop box 200 and employ it to control a remote device either directly via a speech communication capture element in the SB SRM 230, via buttons on the settop box 200, or more preferably by using the SR RCU 100, which receives speech communications from the user and transmits them to the settop box 200. Wireless information transmitted from the SR RCU 100 and received by the settop box 200 is first processed by the SB SRM 230 and then used to execute the identified command or program. Commands transmitted from the settop box 200 may be sent directly to one or more devices, or back to the SR RCU 100, which then relays the wireless transmission (or command) to the one or more devices.

Thus, the settop box 200 possesses all of the features and functionality of previous settop boxes, plus the added capability to process information contained in speech communications received by either the SR RCU 100, or the settop box 200 itself. Providing the settop box 200 with the ability to interpret data contained in a speech communication allows an SR RCU 100 with limited processing and storage capacity to leverage the greater processing and storage capabilities of existing settop boxes. In this way the SR RCU 100 can perform a greater number of tasks of increasing complexity.

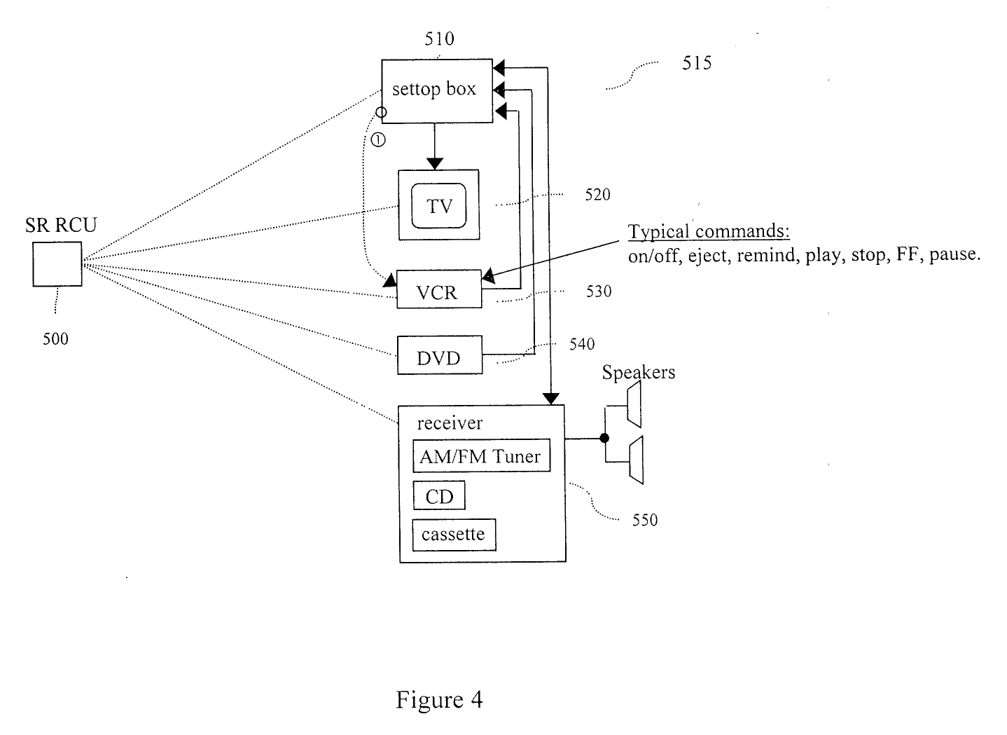

In one embodiment illustrated by FIG. 4, the SR RCU 500 of the present invention is used in combination with a settop box 510 to manipulate a home entertainment system including a television 520, VCR 530, DVD player 540, and stereo system 550. Speech communications are received by the SR RCU 500 and, depending on the type (complexity) of the command, the information is transmitted to the settop box 510, or directly to one of the devices in the entertainment system. The step comparing the information in the speech communication to that in memory in order to interpret the command can be done within the SR RCU 500 or the settop box 510. Infrared technology is a typical means of transmitting commands directly from an SR RCU 500 to a device such as a television 520, VCR 530, DVD player 540, or stereo system 550. Alternatively, the wireless information can be sent from the SR RCU 500 to the settop box 510, which in this embodiment also takes place via infrared technology, and from the settop box 510 the command may be sent to one of the devices in the entertainment system 515. Yet another control option, which may depend on the complexity of the command and/or the layout of the system, would have the speech communication content received by the SR RCU, transmitted to the settop box for processing of the command, and then transmitted back from the settop box to the SR RCU, which relays it to another device in the system.

The initial setup programming for the commands may be performed in either the SR RCU 500 or the settop box 510. Recording of commands in the settop box 510 is one example of how information in speech communications may be received by the SR RCU 500, sent via wireless transmission to the settop box 510 where it is associated with a command, and where the information in the command is then sent either via cable or wireless transmission to one of the devices in the entertainment system 515, either directly or via relay to the SR RCU 500 and then to the system 515.

A mechanism for receiving wireless information is also included in the SR RCU 500. One application of this capability is also illustrated by the situation where commands are recorded in the settop box. In one embodiment, certain commands may only be executable by a device if they are received directly from the SR RCU 500, or in another embodiment the system may be designed so that all of the processing, programming, and recording is performed in the settop box 510, and information is never communicated directly from the settop box 510 to a device. In either embodiment, speech communications may be received by the SR RCU 500, which sends the information contained in the speech communication to the settop box 510 via wireless transfer where the settop box 510 associates the information with a certain command. The information necessary to execute the command can then be sent back to the SR RCU 500 via wireless transmission, and relayed from the SR RCU 500 to the appropriate device the entertainment system 515.

Thus, by tapping into the SB's 200 greater storage and processing capacity, the present invention is able to use a simple SR RCU 100 to provide users with more powerful speech recognition and control over an entertainment system.

While the present invention has been illustrated and described in terms of particular apparatus and methods of use, it is apparent that equivalent parts may be substituted for those shown and other changes can be made within the scope of the present invention as defined by the appended claims.

The particular embodiments disclosed herein are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What we claim as our invention is:

1. A speech recognition remote control unit (SR RCU) comprising:
a processor;
a speech recognition module coupled to said processor for capturing speech communications;
a transmitter coupled to said processor capable of transmitting data to at least a settop box; and
a receiver coupled to said processor capable of receiving data from at least a settop box.

2. The speech recognition remote control unit of claim 1 wherein said speech recognition module converts the captured speech communications to data for sending to at least a settop box via said transmitter.

3. The speech recognition remote control unit of claim 1 wherein said speech recognition module receives wireless data related to said speech communications via said receiver.

4. The speech recognition remote control unit of claim 1 wherein said speech recognition module comprises a speech communication capture element and speech communication software for processing speech communications.

5. The speech recognition remote control unit of claim 4 wherein said speech communication capture element comprises a microphone.

6. The speech recognition remote control unit of claim 4 wherein said speech communication software comprises speech recognition algorithms.

7. The speech recognition remote control unit of claim 1 wherein said speech recognition module converts analog speech communications received to digital data for transmission via said transmitter.

8. The speech recognition remote control unit of claim 1 further comprising memory coupled to said processor for storage of data and software.

9. The speech recognition remote control unit of claim 1 further comprising a button command element coupled to said processor for handling standard button commands of the remote control unit.

10. The speech recognition remote control unit of claim 9 wherein said button command element converts button commands to signals transmitted via said transmitter.

11. The speech recognition remote control unit of claim 9 wherein said speech recognition module converts captured speech communications to button commands.

12. A settop box comprising:
a processor;
a speech recognition module coupled to said processor for capturing speech communications;
a transmitter coupled to said processor capable of transmitting data to at least a SR RCU; and
a receiver coupled to said processor capable of receiving data from at lease a SR RCU.

13. The settop box of claim 12 wherein said data is related to said speech communications and is used to control at least one device in an audio-video system.

14. The settop box of claim 12 wherein said speech recognition module receives captured speech communications from said receiver via a SR RCU.

15. The settop box of claim 12 wherein said speech recognition module receives data related to said speech communications via said receiver.

16. The settop box of claim 12 wherein said speech recognition module comprises a speech communication capture element for capturing speech communications.

17. The settop box of claim 16 wherein said speech communication capture element comprises a microphone. The settop box of claim 16 wherein said speech recognition module converts analog speech communications received to digital data for transmission via said transmitter.

18. The settop box of claim 12 wherein said speech recognition module comprises speech communication software for processing speech communications.

19. The settop box of claim 19 wherein said speech communication software comprises speech recognition algorithms.

20. The settop box of claim 12 further comprising memory coupled to said processor for storage of data and software.

21. The settop box of claim 12 wherein said settop box provides enhanced processing and storage capability for speech recognition functions, and wherein a user can utilize said processing and storage capability via at least an SR RCU.

22. The settop box of claim 12 further comprising a recording module for recording data wherein said recording module can be controlled by speech communications via the speech recognition module.

23. The settop box of claim 12 further comprising a menu module for providing graphical user interface for a user to control functions of the settop box wherein said menu module can be controlled by speech communications via the speech recognition module.

24. A system comprising a speech recognition remote control unit and a settop box wherein:
the speech recognition remote control unit SR RCU comprises:
a SR RCU processor;
a SR RCU speech recognition module coupled to said processor for capturing speech communications and processing the speech communications to create speech-related data; and
a SR RCU transmitter coupled to said processor capable of transmitting speech-related data to a settop box for additional processing relating to the speech communications;
and the settop (SB) box comprises:
a SB processor;
a SB speech recognition module coupled to said processor for processing speech communications; and
a SB receiver coupled to said processor capable of receiving data from a SR RCU.

25. The system of claim 24 wherein said speech communications are employed to control at least one other device in the system.

26. The system of claim 24 wherein the settop box has more sophisticated processing and storage capacity than the SR RCU.

27. The system of claim 24 wherein the processing and storage capacity of the settop box provides enhanced speech recognition capabilities for the SR RCU.

28. The system of claim 24 wherein the processing and storage capacity of the settop box provides enhanced device control options to a user via the SR RCU.

29. The system of claim 24 wherein the SR RCU further comprises a SR RCU receiver coupled to said SR RCU processor capable of receiving data from a settop box relating to the speech communications, and wherein the settop box further comprises a SB transmitter coupled to said SB processor capable of transmitting data to a SR RCU relating to the speech communications.

30. A speech recognition remote control unit (SR RCU) comprising:
a processor;
a speech recognition module coupled to said processor for capturing speech communications and processing the speech communications to create speech-related data; and
a transmitter coupled to said processor capable of transmitting speech-related data to a settop box for additional processing relating to the speech communications.

31. The speech recognition remote control unit of claim 30 further comprising a receiver coupled to said processor capable of receiving data from a settop box relating to the speech communications.

32. The speech recognition remote control unit of claim 31 wherein said speech recognition module receives wireless data related to said speech communications via said receiver.

33. The speech recognition remote control unit of claim 1 further comprising a button command element coupled to said processor for handling standard button commands of the remote control unit, and wherein said speech recognition module converts captured speech communications to button commands.
